(19) United States
(12) Patent Application Publication
(10) Pub. No.: US 2024/0337256 A1
(43) Pub. Date: Oct. 10, 2024

(54) ELECTRO-HYDRAULIC APPARATUS, AND VEHICLE COMPRISING ELECTRO-HYDRAULIC APPARATUS

(71) Applicant: Volvo Construction Equipment AB, Eskilstuna (SE)

(72) Inventors: Kim Heybroek, KVICKSUND (SE); Jan-Ove Palmberg, LINKÖPING (SE); Liselott Ericson, LINKÖPING (SE); Jonas Forssell, TORSLANDA (SE)

(21) Appl. No.: 18/603,408

(22) Filed: Mar. 13, 2024

(30) Foreign Application Priority Data
Apr. 4, 2023 (EP) 23166605.8

(51) Int. Cl. F04B 17/03; F04B 1/128; F04B 1/14

(52) U.S. Cl. CPC F04B 17/03; F04B 1/128; F04B 1/14

(57) ABSTRACT

An electro-hydraulic apparatus comprising a base structure; an electric machine comprising a stator fixed to the base structure and a rotor rotatable about a rotation axis, the rotor being positioned radially inside of the stator with respect to the rotation axis; and a hydraulic machine comprising a revolver fixed to the rotor and including a plurality of cylinders, at least one piston plate, and a plurality of pistons fixed to the at least one piston plate, each piston being arranged to reciprocate inside one of the cylinders during rotation of the revolver to perform suction strokes and discharge strokes. A vehicle comprising an electro-hydraulic apparatus is also provided.

### CROSS REFERENCE TO RELATED APPLICATION

This application claims priority to European Patent Application No. 23166605.8, filed on Apr. 4, 2023, the disclosure and content of which is incorporated by reference herein in its entirety.

### TECHNICAL FIELD

The disclosure relates generally to hydraulics. In particular aspects, the disclosure relates to an electro-hydraulic apparatus and a vehicle comprising an electro-hydraulic apparatus. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Some vehicles comprise a hydraulic pump to provide hydraulic power. For example, a wheel loader may comprise a hydraulic pump to provide hydraulic power for one or more work functions. Electric vehicles of today may comprise a conventional hydraulic pump that is driven by an off-the-shelf electric motor, either indirectly via a mechanical gearbox, or directly in a stacked relationship where the electric motor is positioned next to the hydraulic pump.

### SUMMARY

According to a first aspect of the disclosure, there is provided an electro-hydraulic apparatus comprising a base structure; an electric machine comprising a stator fixed to the base structure and a rotor rotatable about a rotation axis, the rotor being positioned radially inside of the stator with respect to the rotation axis; and a hydraulic machine comprising a revolver fixed to the rotor and including a plurality of cylinders, at least one piston plate, and a plurality of pistons fixed to the at least one piston plate, each piston being arranged to reciprocate inside one of the cylinders during rotation of the revolver to perform suction strokes and discharge strokes.

The first aspect of the disclosure may seek to provide an improved electro-hydraulic apparatus.

A technical benefit may include a more compact design. The electro-hydraulic apparatus may have a higher power density in comparison to conventional electro-hydraulic apparatuses where an electric motor is stacked, i.e., placed next to, a hydraulic pump.

A further technical benefit may include a more cost-efficient design.

A further technical benefit may include a possibility to utilize an inner region radially inside of the cylinders for various functions.

A further technical benefit may include a low number of components for the electro-hydraulic apparatus.

The hydraulic machine of the electro-hydraulic apparatus of the first aspect has an improved performance at high rotational speeds, e.g., at rotational speeds above 2000 rpm, such as above 2500 rpm, such as above 3000 rpm. In particular, the energy efficiency may be high, and a noise level may be low, at high rotational speeds. Due to the improved performance of the hydraulic machine at high rotational speeds, the hydraulic machine enables a lower torque requirement of the electric machine which in turn enables a smaller electric machine to be used.

A further technical benefit may include low churning losses of the hydraulic machine. This improves the efficiency of the hydraulic machine which in turn enables a lower energy consumption.

The electro-hydraulic apparatus is configured to convert electric power to hydraulic power, or vice versa, e.g., by using electric power to drive the electric machine and by using the hydraulic machine to pressurize hydraulic fluid. The electro-hydraulic apparatus can be used in any electrically powered vehicle or machine that requires a hydraulic power supply on-board.

During rotation of the revolver, each piston plate is driven to rotate synchronized with the revolver. Since the pistons are fixed to the at least one piston plate, the hydraulic machine differs from a conventional axial piston pump where the pistons are rotatable on individual slippers. With pistons fixed to the at least one piston plate is meant that the pistons are rigidly connected to the at least one piston plate such that the pistons are immovable relative to the piston plate. For a given angle of the piston plate, the pistons fixed to that piston plate are positioned at a common angle relative to an axis of rotation of the piston plate. In some examples, each piston may be concentric with a unique piston axis. In these examples, the piston axes of all pistons fixed to one piston plate may be parallel during operation of the hydraulic machine. In addition, in these examples, the piston axes of all pistons fixed to one piston plate may be non-parallel with respect to the rotation axis of the rotor.

The revolver may be directly or indirectly fixed to the rotor. For example, a sleeve may be provided between the revolver and the rotor.

According to some examples, one or more of the base structure, the revolver and the piston plates is hollow. According to some examples, each of the base structure, the revolver and the piston plate is hollow. A technical benefit may include that a center opening becomes available for introducing various functions. The center opening may extend through the revolver and into or through the base structure, e.g., on axially opposite sides of the revolver. The center opening may be concentric with the rotation axis.

The base structure may comprise one or more parts. In examples of base structures comprising several parts, the parts may be fixed to each other. The base structure may for example be a housing.

The hydraulic machine may have a fixed displacement or a variable displacement. With a fixed displacement, technical benefits may include a low-complexity design of the hydraulic machine, lower costs and a more optimized efficiency. With a variable displacement, the hydraulic machine has the possibility to change the flow of fluid displaced per revolution. Hence, in an electro-hydraulic apparatus comprising a variable displacement hydraulic machine, the discharge flow from the hydraulic machine can be altered by changing a rotational speed of the electric machine and/or by changing the displacement of the hydraulic machine. A technical benefit of a variable displacement hydraulic machine may include the possibility to use an electric machine of lower rating. With rating is meant a set of electrical and mechanical quantities assigned to an element to define the performance under specified conditions, such as continuous maximum torque output.

The hydraulic machine may be a 1-quadrant, a 2-quadrant or a 4-quadrant hydraulic machine. In case the hydraulic machine is a 1-quadrant hydraulic machine, i.e., comprising only one quadrant, the hydraulic machine only operates as a hydraulic pump with a predefined low-pressure side and a predefined high-pressure side. In case the hydraulic machine is a 2-quadrant hydraulic machine, i.e., comprising only two quadrants, the hydraulic machine can operate both as a hydraulic pump and as a hydraulic motor with a predefined low-pressure side and a predefined high-pressure side. In case the hydraulic machine is a 4-quadrant hydraulic machine, i.e., comprising four quadrants, the hydraulic machine can operate both as a hydraulic pump and as a hydraulic motor in both rotational directions of the hydraulic machine. When the hydraulic machine operates as a hydraulic pump, the electric machine operates as an electric motor delivering mechanical power to the hydraulic machine. Conversely, when the hydraulic machine operates as a hydraulic motor, the electric machine operates as an electric generator receiving mechanical power from the hydraulic machine.

Unless indicated otherwise, a radial direction and an axial direction refer to a radial direction with respect to the rotation axis and an axial direction with respect to the rotation axis, respectively.

In some examples, including in at least one preferred example, optionally each piston plate has a main extension plane. In these examples, each piston may be fixed in an orientation perpendicular to the associated main extension plane. A technical benefit may include reduced frictional losses.

In some examples, including in at least one preferred example, optionally one or more of the pistons fixed to one or more of the at least one piston plate are hollow such that hydraulic fluid can pass through the pistons. In some examples, all pistons fixed to two piston plates are hollow. A technical benefit may include reduced fluid losses. A further technical benefit may include a reduced number of sliding interfaces which may reduce mechanical friction losses. In some examples, all pistons fixed to one piston plate are hollow and all pistons fixed to another piston plate are non-hollow, such as solid, such that hydraulic fluid cannot pass through the pistons.

In some examples, including in at least one preferred example, optionally the electro-hydraulic apparatus comprises an inner region radially inside of the cylinders, and axially within the base structure, with respect to the rotation axis. In these examples, the hydraulic machine may be arranged to provide pressurized hydraulic fluid to the inner region.

In some examples, including in at least one preferred example, optionally the electro-hydraulic apparatus further comprises a center element passing through the revolver.

In some examples, including in at least one preferred example, optionally the center element is fixed to the base structure. A technical benefit may include an increased strength of the base structure.

In some examples, including in at least one preferred example, optionally the center element engages a first section of the base structure and a second section of the base structure on an opposite side of the revolver with respect to the first section. A technical benefit may include that a deflection due to axial forces from the hydraulic machine is compensated for close to where these forces arise (near the pistons). A further technical benefit may include that the base structure is made stiffer than if the base structure is supported radially outside of the inner region. As a consequence, noise characteristics may be improved.

In some examples, the center element comprises a bolt. In these examples, the bolt may threadingly engage the first section and pass through the revolver. Alternatively, or in addition, the bolt may pass through the first section and threadingly engage a nut of the center element outside the first section, e.g., such that the first section is positioned between the nut and the second section. In any case, a head of the bolt may engage the second section. As an alternative to a bolt comprising a head, the bolt may comprise a threaded portion but not a head. In this case, both a first nut and a second nut of the center element may threadingly engage the threaded portion. For example, the first nut may threadingly engage the threaded portion outside of the first section, and the second nut may threadingly engage the threaded portion outside of the second section. Also in this way, the center element may engage the first and second sections of the base structure.

In some examples, including in at least one preferred example, optionally the inner region is positioned entirely inside the center element.

In some examples, including in at least one preferred example, optionally the electro-hydraulic apparatus further comprises at least one fluid bearing supporting the revolver. A technical benefit may include that radial forces caused by pressures within the cylinders can be compensated for. A further technical benefit may include that smaller rolling element bearings can be used, e.g., rolling element bearings supporting the rotor relative to the base structure. The use of smaller rolling element bearings contributes to reduced costs and reduced frictional forces and enables higher rotational speeds. To further reduce costs and friction losses, such smaller rolling element bearings can be positioned in the inner region. In some examples, including in at least one preferred example, optionally the at least one fluid bearing may be positioned within the inner region. The at least one fluid bearing may support the revolver in radial and/or axial directions with respect to the rotation axis.

In some examples, including in at least one preferred example, the at least one fluid bearing is positioned radially inside of the revolver. A technical benefit may include that power losses are kept to a minimum due to low sliding velocities between the at least one fluid bearing and the revolver since the at least one fluid bearing is arranged closed to the rotation axis.

The fluid bearing may support the revolver directly or indirectly. According to some examples, the at least one fluid bearing directly contacts the revolver. According to some examples, the at least one fluid bearing supports an intermediate element between the at least one fluid bearing and the revolver, such as a shaft of a center element fixed to the revolver. In these examples, the at least one fluid bearing may comprise two fluid bearings and the revolver may be positioned axially between the fluid bearings. The shaft may be directly or indirectly fixed to the revolver. For example, a sleeve may be provided between the shaft and the revolver.

In some examples, including in at least one preferred example, optionally each fluid bearing is a hydrostatic bearing provided with pressurized hydraulic fluid from the hydraulic machine. A technical benefit may include that a force on the at least one fluid bearing is automatically adjusted in accordance with an operating pressure of the hydraulic machine. A further technical benefit may include a less complicated design.

In some examples, including in at least one preferred example, optionally the at least one fluid bearing is provided with pressurized hydraulic fluid via the inner region. Technical benefits may include a more compact design and a more cost-efficient design.

In some examples, including in at least one preferred example, optionally each fluid bearing is a hydrodynamic bearing. A technical benefit may include a more cost-efficient solution. For example, a channel for conducting oil to the hydrodynamic bearing may be omitted.

In some examples, including in at least one preferred example, optionally the center element comprises a shaft fixed to the revolver. A technical benefit may include enabling a radially more compact design of the electro-hydraulic apparatus, for example since bearings (rolling element bearings or fluid bearings) can be provided on the center element axially outside of the revolver.

In some examples, including in at least one preferred example, optionally the electro-hydraulic apparatus further comprises a rolling element bearing on each side of the revolver supporting rotation of the shaft relative to the base structure. Technical benefit may include an enabled use of smaller bearings and a reduced size of the electro-hydraulic apparatus.

In some examples, including in at least one preferred example, optionally the at least one piston plate comprises a first piston plate and a second piston plate arranged on an opposite side of the revolver with respect to the first piston plate. The first and second piston plates may be mirrored in a plane transverse to the rotation axis. The revolver may be positioned between the first and second piston plates along the rotation axis. In some examples, each cylinder is a through hole extending through the revolver in parallel with the rotation axis. In these examples, each cylinder may accommodate one piston of the first piston plate and one piston of the second piston plate. A technical benefit may include a more cost-efficient production of the revolver. A further technical benefit may include lower requirements on axial force handling by any bearings supporting the revolver since there may be virtually no hydraulic axial forces acting on the revolver.

In some examples, including in at least one preferred example, optionally each cylinder is oriented in parallel with the rotation axis. A longitudinal axis of each cylinder may thus be parallel with the rotation axis. In these examples, the piston axes of all pistons fixed to one piston plate may be non-parallel with respect to the cylinders.

In some examples, including in at least one preferred example, optionally the electro-hydraulic apparatus comprises two hydraulic ports on a same side of the revolver as the first piston plate and two hydraulic ports on a same side of the revolver as the second piston plate. In these examples, at least one hydraulic port on the same side of the revolver as the first piston plate may be in fluid communication with at least one hydraulic port on the same side of the revolver as the second piston plate. Each hydraulic port may be configured to communicate hydraulic fluid.

In some examples, including in at least one preferred example, optionally at least one hydraulic port of the hydraulic ports on the same side of the revolver as the first piston plate and at least one hydraulic port of the hydraulic ports on the same side of the revolver as the second piston plate are in fluid communication through the inner region, e.g. via at least one inner channel. The inner region may thus be used to route hydraulic fluid between axially opposite sides of the base structure. A technical benefit may include a more compact design of the electro-hydraulic apparatus. In these examples, the at least one inner channel may be arranged between two high-pressure hydraulic ports.

In some examples, including in at least one preferred example, optionally the electro-hydraulic apparatus comprises at least one outer channel passing radially outside of the stator with respect to the rotation axis and along the stator for communicating fluid between at least one hydraulic port of the hydraulic ports on the same side of the revolver as the first piston plate and at least one hydraulic port of the hydraulic ports on the same side of the revolver as the second piston plate. A technical benefit may include a more efficient cooling of the stator of the electric machine. A further technical benefit may include an elimination of dedicated cooling channels, e.g., containing coolant fluidically separated from the hydraulic fluid used by the hydraulic machine. A single outer channel may branch into a plurality of sub-channels away from one port, and the plurality of sub-channels may merge into a single outer channel towards an opposite port, e.g., on an axially opposite side of the revolver. In these examples, the at least one outer channel may be arranged between two low-pressure hydraulic ports.

In some examples, including in at least one preferred example, optionally the electro-hydraulic apparatus is arranged such that the discharge strokes of the pistons fixed to the first piston plate are out of phase with the discharge strokes of the pistons fixed to the second piston plate. A technical benefit may include a reduced noise, e.g., due to a lower energy of each pressure pulse which can more easily be suppressed. A further technical benefit may include that a pulse frequency becomes increased which may lead to less resonances in the base structure, resulting in less noise.

In some examples, including in at least one preferred example, optionally the cylinders comprise first cylinders receiving the pistons fixed to the first piston plate and second cylinders receiving the pistons fixed to the second piston plate. In these examples, the revolver may comprise a wall separating the first cylinders from the second cylinders. In some examples, the second cylinders have an angular offset relative to the first cylinders in a plane transverse to the rotation axis.

In some examples, including in at least one preferred example, optionally the first cylinders and the second cylinders are rotationally offset with respect to the rotation axis.

In some examples, optionally the electro-hydraulic apparatus is arranged such that the discharge strokes of the pistons fixed to the first piston plate are in phase with the discharge strokes of the pistons fixed to the second piston plate. In these examples, the pistons fixed to the first piston plate may be mirrored with the pistons fixed to the second piston plate in a plane transverse to the rotation axis. Moreover, each chamber may house one piston of each of the first and second piston plates. Technical benefits may include reduced axial force components, reduced noise and improved efficiency.

In some examples, including in at least one preferred example, optionally the electro-hydraulic apparatus comprises only two hydraulic ports.

In some examples, including in at least one preferred example, optionally the two hydraulic ports comprise only one hydraulic port on a same side of the revolver as the first piston plate and only one hydraulic port on a same side of the revolver as the second piston plate.

In some examples, including in at least one preferred example, optionally the two hydraulic ports are positioned on a same side of the revolver as one piston plate. A technical benefit may include a convenient installation of the electro-hydraulic apparatus.

According to a second aspect of the disclosure, there is provided a vehicle comprising an electro-hydraulic apparatus according to the first aspect. The vehicle may be a construction vehicle, such as a wheel loader, an excavator or a hauler. The vehicle may comprise an electric power source for electrically powering the electro-hydraulic apparatus.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary side view of a vehicle according to an example.

FIG. 2 is an exemplary side view of a vehicle according to a further example.

FIG. 3 is an exemplary side view of a vehicle according to a further example.

FIG. 4 is an exemplary top view of an electro-hydraulic apparatus according to one example.

FIG. 5 is an exemplary end view of plenums according to one example.

FIG. 6 is an exemplary end view of a valve plate according to one example.

FIG. 7 is an exemplary perspective view of a piston plate and pistons according to one example.

FIG. 8 is an exemplary cross-sectional view of section A-A in FIG. 7.

FIG. 9 is an exemplary cross-sectional side view of the electro-hydraulic apparatus in FIG. 4.

FIG. 10 is an exemplary cross-sectional side view of an electro-hydraulic apparatus according to a further example.

FIG. 11 is an exemplary cross-sectional side view of an electro-hydraulic apparatus according to a further example.

FIG. 12 is an exemplary cross-sectional side view of a hydrostatic bearing according to one example.

FIG. 13 is an exemplary side view of a hydrodynamic bearing according to one example.

FIG. 14 is an exemplary top view of the electro-hydraulic apparatus in FIG. 11.

FIG. 15 is an exemplary view of one end of the electro-hydraulic apparatus in FIGS. 11 and 14.

FIG. 16 is a further exemplary view of one end of the electro-hydraulic apparatus in FIGS. 11 and 14.

FIG. 17 is an exemplary top view of a base structure and an outer channel according to one example.

FIG. 18 is an exemplary top view of an electro-hydraulic apparatus according to a further example.

FIG. 19 is an exemplary top view of an electro-hydraulic apparatus according to a further example.

FIG. 20 is an exemplary top view of an electro-hydraulic apparatus according to a further example.

FIG. 21 is an exemplary top view of an electro-hydraulic apparatus according to a further example.

FIG. 22 is an exemplary top view of an electro-hydraulic apparatus according to a further example.

FIG. 23 is an exemplary cross-sectional side view of an electro-hydraulic apparatus according to a further example.

FIG. 24 is an exemplary cross-sectional side view of a revolver according to one example.

FIG. 25 is an exemplary end view of the revolver in FIG. 24.

FIG. 26 is an exemplary cross-sectional side view of an electro-hydraulic apparatus according to a further example.

FIG. 27 is an exemplary cross-sectional side view of an electro-hydraulic apparatus according to a further example.

FIG. 28 is an exemplary cross-sectional side view of an electro-hydraulic apparatus according to a further example.

FIG. 29 is an exemplary top view of the electro-hydraulic apparatus in FIG. 28.

FIG. 30 is an exemplary cross-sectional side view of an electro-hydraulic apparatus according to a further example.

FIG. 31 is another view of FIG. 4, according to an example.

### DETAILED DESCRIPTION

The detailed description set forth below provides information and examples of the disclosed technology with sufficient detail to enable those skilled in the art to practice the disclosure.

Hydraulic pumps according to the prior art are generally optimized to match with the characteristics of a combustion engine. Such hydraulic pumps are often limited in rotational speed, e.g., to around 2000 rpm (revolutions per minute). One example of such conventional hydraulic pump is an axial piston pump.

When such conventional hydraulic pump is driven by an electric machine, either a high-torque electric machine, or an intermediate mechanical gearbox is needed to meet the torque demand of the hydraulic pump. Prior art implementations of a hydraulic pump driven by an electric machine are thus bulky and expensive. When introducing an additional gearbox, the electric machine can be of smaller size, but such downsizing comes at the expense of additional energy conversion losses, potential noise and gearbox maintenance (such as regular oil-change).

An increase of the rotational speed of prior art hydraulic pumps, e.g., to rotational speeds above 2000 rpm, may introduce or amplify several drawbacks. One example of such drawback is an increase of drag losses due to viscous losses between internal rotary parts and a stationary housing of the hydraulic pump. A further example of such drawback is an imbalance of internal forces. For example, as the rotational speed is increased, the friction between moving parts increase and may cause tipping moments of internal parts, such as cylinder barrels and pistons. A further example of such drawback is cavitation. For example, as the rotational speed is increased, the oil velocity increases causing increased pressure drops in inlet hydraulic ports which at some point results in cavitation. A further example of such drawback is noise. For example, as the rotational speed is increased, the pulsation frequency from pistons increases which might result in unpleasant noise for the human car.

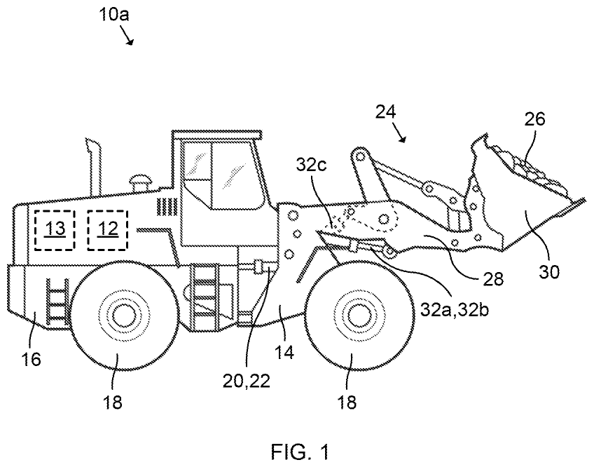

FIG. 1 is an exemplary side view of a vehicle according to an example. The vehicle in FIG. 1 is a wheel loader 10a. The wheel loader 10a comprises an electro-hydraulic apparatus 12 according to the present disclosure. Moreover, the wheel loader 10a comprises an electric power source 13 for electrically powering the electro-hydraulic apparatus 12. The electric power source 13 may for example be an electric power connection to an external power supply from outside of the wheel loader 10a, a direct current, DC, connection in the wheel loader 10a, an alternating current, AC, connection in the wheel loader 10a, an electric generator driven by a combustion engine of the wheel loader 10a, or an electric storage device, such as a battery pack.

The wheel loader 10a of this specific and non-limiting example comprises a front body section 14 and a rear body section 16, which sections each has an axle for driving a pair of wheels 18. The body sections 14, 16 are connected to each other in such a way that they can pivot in relation to each other around a vertical axis by means of two first actuators in the form of hydraulic cylinders 20, 22 arranged between the two body sections 14, 16. The hydraulic cylinders 20, 22 are thus arranged one on each side of a horizontal centerline of the wheel loader 10a in a traveling direction in order to turn the wheel loader 10a.

The wheel loader 10a of this example further comprises an equipment 24 for handling objects or material 26. The equipment 24 comprises a load-arm unit 28, also referred to as a linkage, and an implement in the form of a bucket 30 fitted on the load-arm unit 28. A first end of the load-arm unit 28 is pivotally connected to the front body section 14. The bucket 30 is pivotally connected to a second end of the load-arm unit 28. The load-arm unit 28 with the bucket 30 thereon can be raised and lowered relative to the front body section 14 by means of two boom or lifting hydraulic cylinders 32a, 32b, each of which is connected at one end to the front body section 14 and at the other end to the load-arm unit 28. The bucket 30 can be tilted relative to the load-arm unit 28 by means of a bucket or tilting hydraulic cylinder 32c. The wheel loader 10a is mainly used to move material 26 from one position to another. The initial position may be often a pile of some material 26, and the other position may be a load receiver. Each hydraulic cylinder 20, 22 and 32a-32c is hydraulically powered by the electro-hydraulic apparatus 12. The vehicle 10a comprises an electric power source for electrically powering the electro-hydraulic apparatus 12.

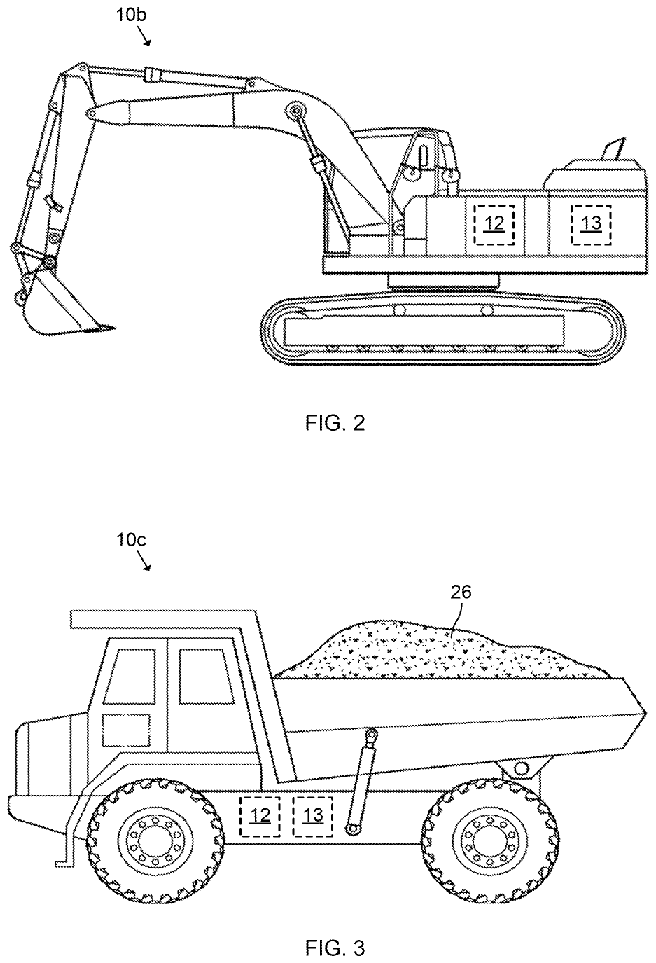

FIG. 2 is an exemplary side view of a vehicle according to a further example. The vehicle in FIG. 2 is an excavator 10b. The excavator 10b comprises an electro-hydraulic apparatus 12 according to the present disclosure and an electric power source 13 for electrically powering the electro-hydraulic apparatus 12.

FIG. 3 is an exemplary side view of a vehicle according to a further example. The vehicle in FIG. 3 is a hauler 10c for handling material 26. The hauler 10c comprises an electro-hydraulic apparatus 12 according to the present disclosure and an electric power source 13 for electrically powering the electro-hydraulic apparatus 12.

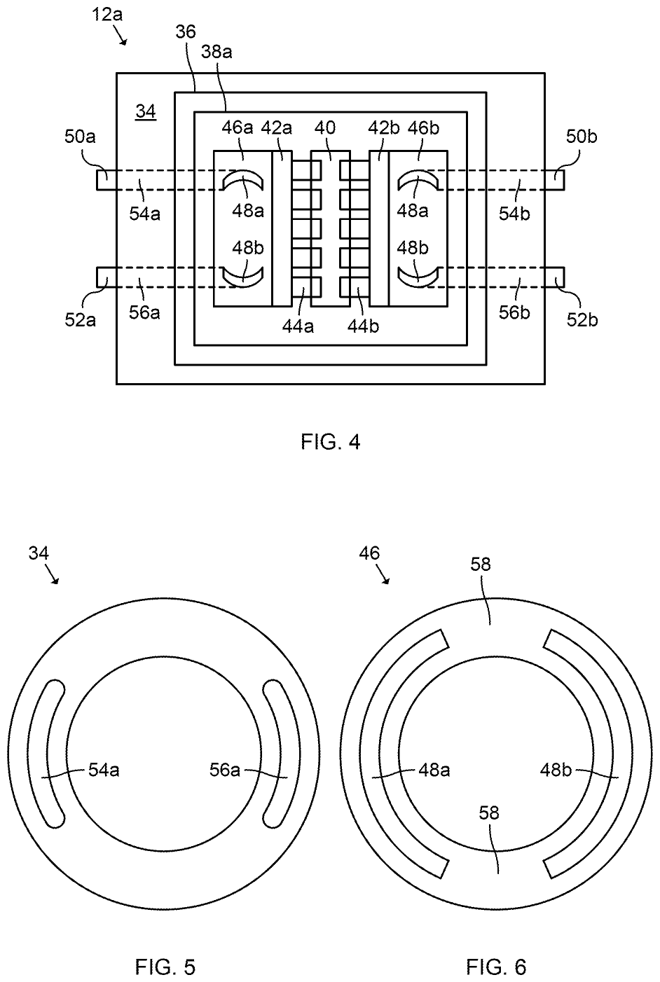

FIG. 4 is an exemplary top view of an electro-hydraulic apparatus 12a according to one example. The electro-hydraulic apparatus 12a comprises a housing 34, an electric machine 36 and a hydraulic machine 38a. The housing 34 is one example of a base structure according to the present disclosure.

The hydraulic machine 38a in FIG. 4 may be of the type described in EP 3693603 A1, the content of which is incorporated by reference in its entirety. It has been found that the hydraulic machine 38a is particularly suitable to operate at high rotational speeds, e.g., at rotational speeds above 2000 rpm, such as above 2500 rpm, such as above 3000 rpm.

The hydraulic machine 38a of this example comprises a revolver 40, a first piston plate 42a, a plurality of first pistons 44a fixed to the first piston plate 42a, a second piston plate 42b, and a plurality of second pistons 44b fixed to the second piston plate 42b. As shown, the revolver 40 is positioned between the first and second piston plates 42a, 42b. The first pistons 44a are positioned between the first piston plate 42a and the revolver 40 and extend into the revolver 40. The second pistons 44b are positioned between the second piston plate 42b and the revolver 40 and extend into the revolver 40.

The hydraulic machine 38a of this example further comprises a valve plate associated with each piston plate 42a, 42b, here a first valve plate 46a and a second valve plate 46b. The first piston plate 42a is positioned between the first valve plate 46a and the revolver 40. The second piston plate 42b is positioned between the second valve plate 46b and the revolver 40. In this example, each valve plate 46a, 46b comprises a first passageway 48a and a second passageway 48b.

The electro-hydraulic apparatus 12a of this example further comprises a first high-pressure hydraulic port 50a and a first low-pressure hydraulic port 52a at a first side of the housing 34, and a second high-pressure hydraulic port 50b and a second low-pressure hydraulic port 52b at a second side of the housing 34, opposite to the first side.

The electro-hydraulic apparatus 12a of this example further comprises a first high-pressure plenum 54a for providing fluid communication between the first high-pressure hydraulic port 50a and the first passageway 48a of the first valve plate 46a. The electro-hydraulic apparatus 12a of this example further comprises a first low-pressure plenum 56a for providing fluid communication between the first low-pressure hydraulic port 52a and the second passageway 48b of the first valve plate 46a. The electro-hydraulic apparatus 12a of this example further comprises a second high-pressure plenum 54b for providing fluid communication between the second high-pressure hydraulic port 50b and the first passageway 48a of the second valve plate 46b. The electro-hydraulic apparatus 12a of this example further comprises a second low-pressure plenum 56b for providing fluid communication between the second low-pressure hydraulic port 52b and the second passageway 48b of the second valve plate 46b.

FIG. 5 is an exemplary end view of plenums 54a, 56a according to one example. As shown, the plenums 54a, 56a are here provided in a part of the housing 34. The plenums 54b, 56b may be of the same design as the plenums 54a, 56a.

FIG. 6 is an exemplary end view of a valve plate 46 according to one example. One or each of the valve plates 46a, 46b may be constituted by the valve plate 46. The valve plate 46 of this example is hollow. The valve plate 46 comprises a land area 58 between each pair of ends of the passageways 48a, 48b.

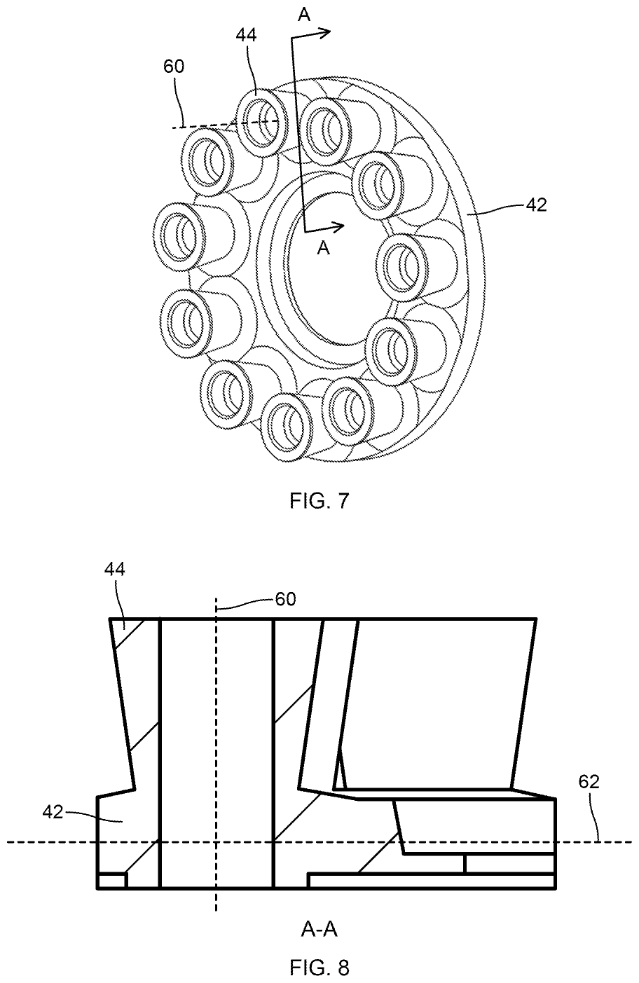

FIG. 7 is an exemplary perspective view of a piston plate 42 and pistons 44 according to one example. The piston plate 42 may constitute one or each of the piston plates 42a, 42b. Alternatively, or in addition, the pistons 44 may constitute the first pistons 44a and/or the second pistons 44b. The pistons 44 are rigidly affixed to the piston plate 42. The pistons 44 are thus immovable relative to the piston plate 42.

As shown in FIG. 7, each piston 44 has an associated piston axis 60. In this example, each piston 44 is concentric with respect to its associated piston axis 60. FIG. 7 further shows a section A-A.

FIG. 8 is an exemplary cross-sectional view of section A-A in FIG. 7. FIG. 8 shows a main extension plane 62 of the piston plate 42. The piston plate 42 of this example is substantially flat in an orientation defining the main extension plane 62. Each piston 44 is fixed in an orientation transverse to the main extension plane 62.

In the example in FIG. 8, each piston 44 is hollow. Each piston 44 thereby allows hydraulic fluid to pass therethrough, along the respective piston axis 60. Hydraulic fluid can thereby flow between the first valve plate 46a and the revolver 40 through the first pistons 44a, and between the second valve plate 46b and the revolver 40 through the second pistons 44b.

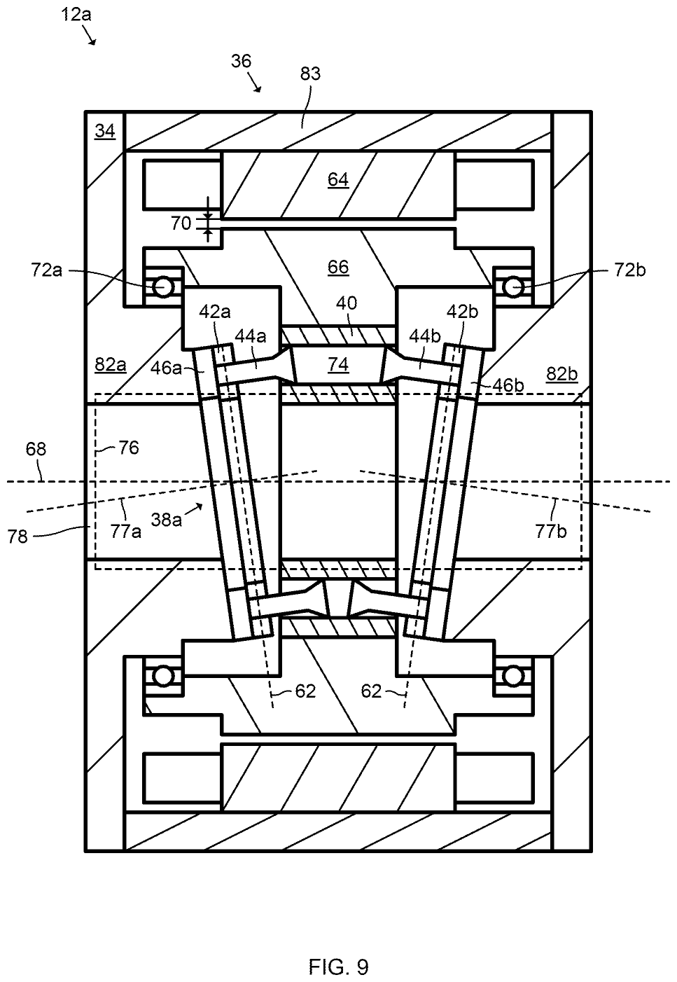

FIG. 9 is an exemplary cross-sectional side view of the electro-hydraulic apparatus 12a in FIG. 4. The electric machine 36 comprises a stator 64 and a rotor 66. The stator 64 is fixed to the housing 34. The rotor 66 is rotatable relative to the stator 64 about a rotation axis 68. A radial airgap 70 is provided between the rotor 66 and the stator 64. The rotor 66 is positioned radially inside of the stator 64 with respect to the rotation axis 68. The rotor 66 is hollow. The revolver 40 is fixed to the rotor 66 radially inside of the rotor 66.

The electro-hydraulic apparatus 12a of this example further comprises a first rolling element bearing 72a and a second rolling element bearing 72b. The rolling element bearings 72a, 72b are connected to the housing 34 and to the rotor 66. The revolver 40 is positioned axially between the rolling element bearings 72a, 72b. The rolling element bearings 72a, 72b are here illustrated as radial bearings but may alternatively be thrust bearings, such as angular contact bearings.

The revolver 40 comprises a plurality of cylinders 74. In this example, each cylinder 74 receives one first piston 44a and one second piston 44b therein. Moreover, in this example, each cylinder 74 is a through hole extending through the revolver 40 in parallel with the rotation axis 68.

FIG. 9 further shows an inner region 76. The inner region 76 is positioned radially inside of the cylinders 74, and axially within the housing 34 with respect to the rotation axis 68. In this example, the rolling element bearings 72a, 72b are positioned radially outside of the inner region 76.

As shown in FIG. 9, the piston plates 42a, 42b of this example are angled relative to each other. The first piston plate 42a is angled (counterclockwise from vertical in FIG. 9) in a first direction about an axis transverse to the rotation axis 68 (normal to the view in FIG. 9) and the second piston plate 42b is angled (clockwise from vertical in FIG. 9) in a second direction, opposite to the first direction, about an axis transverse to the rotation axis 68 (normal to the view in FIG. 9). In FIG. 9, the piston plates 42a, 42b are thus mirrored in an imaginary plane transverse to the rotation axis 68 and passing through a center of the revolver 40.

The first piston plate 42a is rotatable about a first piston plate axis 77a. The second piston plate 42b is rotatable about a second piston plate axis 77b. The first piston plate axis 77a is angled relative to the rotation axis 68 in a counterclockwise direction (in FIG. 9) and the second piston plate axis 77b is angled relative to the rotation axis 68 in a clockwise direction (in FIG. 9).

In this example, the first piston plate 42a mates with the first valve plate 46a and the second piston plate 42b mates with the second valve plate 46b. The first piston plate 42a is parallel with the first valve plate 46a, and the second piston plate 42b is parallel with the second valve plate 46b. Each of the first and second valve plates 46a, 46b is fixed to the housing 34 in this example. All first pistons 44a are fixed to the first piston plate 42a at right angle to the first valve plate 46a, i.e., parallel with a normal of the first valve plate 46a. All second pistons 44b are fixed to the second piston plate 42b at right angle to the second valve plate 46b, i.e. parallel with a normal of the second valve plate 46b.

During rotation of the rotor 66, the revolver 40 rotates in common with the rotor 66. The rotation of the revolver 40 drives rotation of the pistons 44a, 44b and the piston plates 42a, 42b, here in the respective main extension planes 62 of the piston plates 42a, 42b to rotate about the respective piston plate axes 77a, 77b. Each piston 44a, 44b thereby performs a reciprocating motion inside a respective cylinder 74 during rotation of the revolver 40. When a pair of a first piston 44a and a second piston 44b in a common cylinder 74 is entirely closed by any of the land areas 58 and when the land areas 58 do not overlap any of the plenums 54a, 54b, 56a, 56b, the volume within this pair of pistons 44a, 44b and within this cylinder 74 is closed and disconnected from all plenums 54a, 54b, 56a, 56b, which are integrally formed in the housing 34 in this example. When the pistons 44a, 44b move towards each other in parallel with the rotation axis 68, the volume decreases and the hydraulic fluid therein is pre-compressed. Conversely, when the pistons 44a, 44b move away from each other in parallel with the rotation axis 68, the volume increases and the hydraulic fluid therein is decompressed. Once a piston 44a, 44b starts to overlap any of the passageways 48a, 48b, the interior of the piston 44a, 44b is brought in fluid communication with one or more of the hydraulic ports 50a, 50b, 52a, 52b given that the passageways 48a, 48b overlap the respective plenums 54a, 54b, 56a, 56b. In this case, hydraulic fluid may either be sucked into the cylinder 74 or discharged from the cylinder 74. In this way, the pistons 44a, 44b are arranged to reciprocate inside respective cylinders 74 by rotation of the revolver 40 to perform suction strokes and discharge strokes. In the hydraulic machine 38a, discharge strokes of the first pistons 44a are in phase with the discharge strokes of the second pistons 44b.

In this example, each valve plate 46a, 46b, each piston plate 42a, 42b and the revolver 40 is hollow. Moreover, at least a part of the housing 34 along the rotation axis 68 is hollow in this example. A center opening 78 is thereby formed. The center opening 78 is here concentric with the rotation axis 68.

As shown in FIG. 9, the electro-hydraulic apparatus 12a has a very compact design. Moreover, in comparison with a prior art hydraulic pump, such as a conventional axial piston pump, the hydraulic machine 38a is improved in terms of maximum rotational speed, efficiency and possibilities to reduce or control the noise level.

The hydraulic machine 38a of the specific and non-limiting example in FIG. 9 has a fixed displacement and four quadrants. Moreover, the hydraulic machine 38a is a double hydraulic machine, i.e., comprising two piston plates 42a, 42b and associated pistons 44a, 44b. The hydraulic machine 38a therefore has a form-factor (long and slender) suitable for fitting inside the electric machine 36, enabling a high power density of the electro-hydraulic apparatus 12a.

Due to the pistons 44a, 44b being fixed to the respective piston plates 42a, 42b, there are no issues from centrifugal forces on the pistons 44a, 44b and virtually no forces or torques are transmitted via sliding interfaces between the pistons 44a, 44b and the revolver 40. This results in very low losses, low force unbalances, and low tipping moments on the pistons 44a, 44b. For slipper-type pistons in contrast, centrifugal forces on the pistons cause increased friction, tipping moments of the pistons, and noise, which are all factors limiting the maximum rotational speed of the hydraulic machine 38a. The hydraulic machine 38a has small vibrations during operation and a very high efficiency.

As can be gathered from FIG. 9, the design of the hydraulic machine 38a enables the pistons 44a, 44b to have a relatively short stroke. This in turn reduces pressure pulsations.

By driving the hydraulic machine 38 at high rotational speeds, the required torque provided by the electric machine 36 can be relatively low. This enables a size of the electric machine 36 to be reduced. As a consequence, the electro-hydraulic apparatus 12a can be made more compact.

As shown in FIG. 9, the rolling element bearings 72a, 72b are positioned radially outside of the center opening 78 and the inner region 76, here also radially outside of the revolver 40. The center opening 78 thus becomes available for various functions as described herein. The hydraulic machine 38a is positioned axially between the first and second sections 82a, 82b.

As shown in FIG. 9, the housing 34 of this example comprises a first section 82a and a second section 82b. Moreover, the housing 34 of this example further comprises a central section 83. The central section 83 is positioned between the first and second sections 82a, 82b. In this example, each of the first and second sections 82a, 82b is fixed to the central section 83. The stator 64 is here fixed to the central section 83, radially inside of the central section 83.

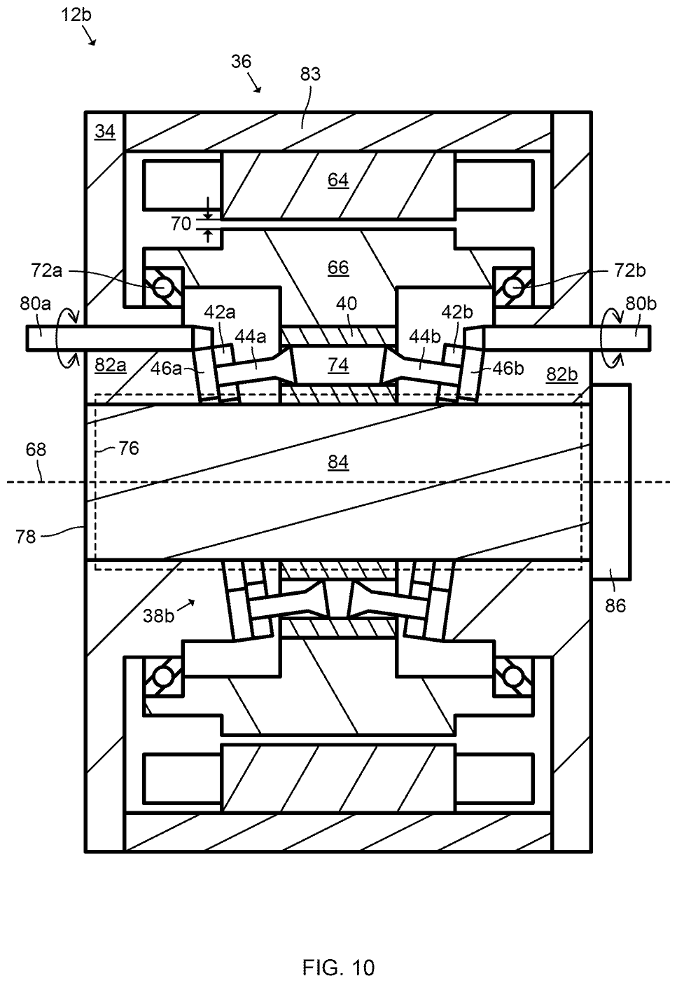

FIG. 10 is an exemplary cross-sectional side view of an electro-hydraulic apparatus 12b according to a further example. Mainly differences with respect to the electro-hydraulic apparatus 12a will be described. The electro-hydraulic apparatus 12b of this example comprises a hydraulic machine 38b, a first rotation control element 80a and a second rotation control element 80b. The rotation control elements 80a, 80b are associated with the first and second valve plates 46a, 46b, respectively, here by a gear engagement therebetween. By manipulating the first rotation control element 80a, such as by rotation, the first valve plate 46a can be rotated, e.g. about the first piston plate axis 77a. The second valve plate 46b can be rotated by the second rotation control element 80b in a corresponding manner, e.g. about the second piston plate axis 77b. By rotating the first and/or second valve plates 46a, 46b relative to the plenums 54a, 54b, 56a, 56b, the displacement of the hydraulic machine 38b can be changed. The hydraulic machine 38b thus has a variable displacement. Moreover, by rotating the first and/or second valve plates 46a, 46b, such as with unequal angles, the pre-compression and decompression characteristics of the hydraulic fluid in the cylinders 74 can be changed.

When the displacement of the hydraulic machine 38b is reduced, also the torque required by the electric machine 36 to produce a certain fluid pressure can be reduced. This may be useful to extend an operating range of the electro-hydraulic apparatus 12b in terms of flow and pressure in relation to the characteristics of the electric machine 36. The use of a variable displacement hydraulic machine 38b thus enables a rating of the electric machine 36 to be reduced. By changing the discharge flow by changing the displacement of the hydraulic machine 38b, the discharge flow can be changed more dynamically compared to quickly changing a rotational speed of the electric machine 36 which requires additional torque from the electric machine 36 to accelerate/decelerate the rotational mass of the movable parts of the electro-hydraulic apparatus 12b.

In FIG. 10, the rolling element bearings 72a, 72b are illustrated as angular contact bearings. However, the rolling element bearings 72a, 72b of the electro-hydraulic apparatus 12b may be of alternative types, such as radial bearings.

The electro-hydraulic apparatus 12b of this example further comprises a bolt 84. The bolt 84 is one example of a center element according to the present disclosure. As shown, the bolt 84 passes through the inner region 76. The bolt 84 comprises a head 86. The bolt 84 passes through the revolver 40 along the rotation axis 68. The bolt 84 is thus concentric with the rotation axis 68. The bolt 84, here a tip thereof, threadingly engages the first section 82a. By tightening the bolt 84, the head 86 is forced against the second section 82b. The bolt 84 thereby rigidly secures the first and second sections 82a, 82b and holds the first and second sections 82a, 82b tightly together. Due to the bolt 84 in the inner region 76 engaging the first and second sections 82a, 82b, the housing 34 becomes very stiff. This is advantageous since the housing 34 can thereby more efficiently handle large axial forces produced by the hydraulic machine 38b. Moreover, noise due to vibrations can be reduced.

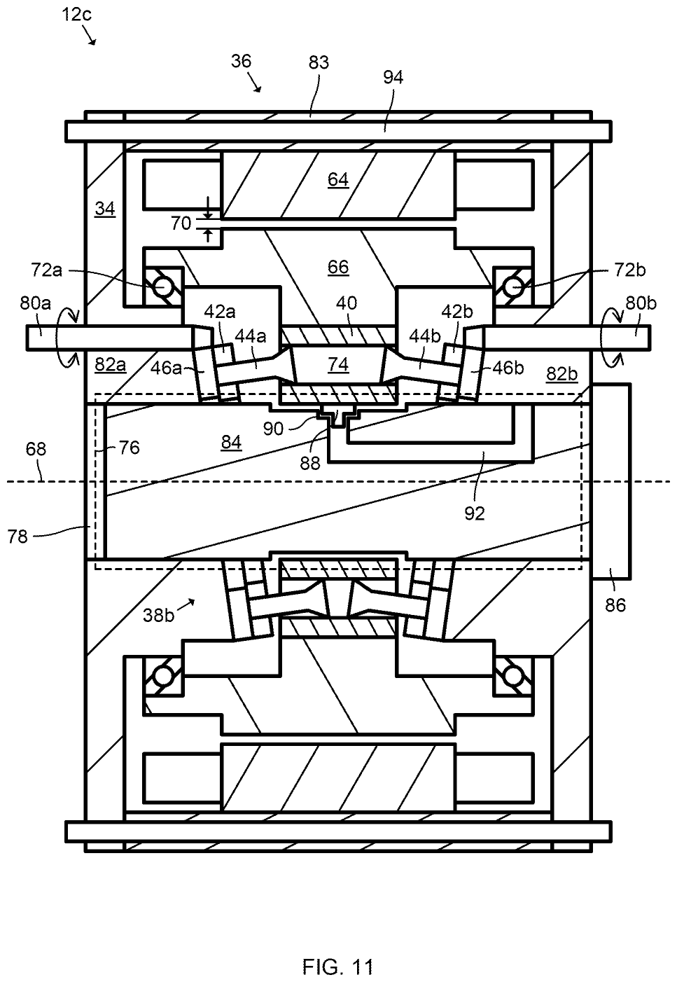

FIG. 11 is an exemplary cross-sectional side view of an electro-hydraulic apparatus 12c according to a further example. Mainly differences with respect to the electro-hydraulic apparatuses 12a, 12b will be described. The electro-hydraulic apparatus 12c comprises a hydrostatic bearing 88. The hydrostatic bearing 88 supports the revolver 40. The hydrostatic bearing 88 is positioned radially inside of the revolver 40. The hydrostatic bearing 88 is here provided in the inner region 76, in this example in the bolt 84. The hydrostatic bearing 88 provides radial force compensation of the revolver 40. The hydrostatic bearing 88 is received in a seat 90, here in the bolt 84. The hydrostatic bearing 88 is one example of a fluid bearing according to the disclosure.

The electro-hydraulic apparatus 12c further comprises an inner channel 92. The inner channel 92 supplies hydraulic fluid to the hydrostatic bearing 88, here via the inner region 76. The inner channel 92 of this example passes inside the bolt 84, between the housing 34, here the second section 82b thereof, and the hydrostatic bearing 88. Pressurized hydraulic fluid in fluid communication with one or both high-pressure hydraulic ports 50a, 50b is led into the inner channel 92. The hydrostatic bearing 88 is thus provided with pressurized hydraulic fluid from the hydraulic machine 38b. When the pressure in the inner channel 92 is relatively high or relatively low, the hydrostatic bearing 88 is forced radially outwards against the inner surface of the revolver 40 with a relatively high force or a relatively low force, respectively. A force on the hydrostatic bearing 88 is thereby automatically adjusted in accordance with an operating pressure of the hydraulic machine 38b. A technical effect may include that a radial force resultant from the hydraulic pressures within the hydraulic machine 38b is absorbed by the hydrostatic bearing 88. A technical benefit of this effect may include that rolling element bearings, such as the rolling element bearings 72a, 72b, become unloaded. This in turn enables an increased life and/or a reduced rating of the rolling element bearings.

The electro-hydraulic apparatus 12c of this example further comprises a plurality of outer channels 94. As shown, the outer channels 94 pass radially outside of the stator 64, here through the housing 34, more specifically through the central section 83 thereof. By conducting hydraulic fluid through the outer channel 94, the stator 64 can be cooled.

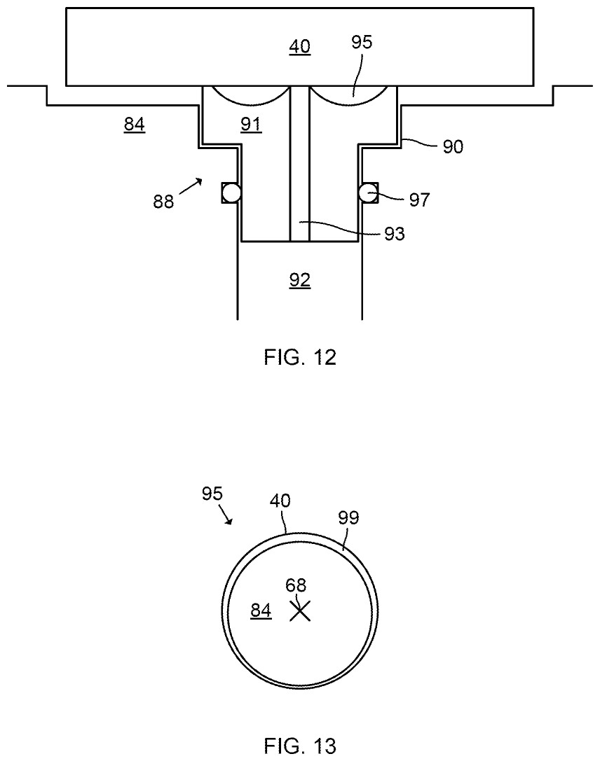

FIG. 12 is an exemplary cross-sectional side view of the hydrostatic bearing 88. The hydrostatic bearing 88 of this specific example comprises a hydrostatic piston 91 seated in the seat 90. The hydrostatic piston 91 comprises a channel 93 that leads fluid, here hydraulic fluid, from the inner channel 92 to a pocket 95 between the hydrostatic piston 91 and the revolver 40. The hydrostatic piston 91 may for example have a curved rectangular shape. The hydrostatic bearing 88 of this specific example further comprises an O-ring 97 sealing between the hydrostatic piston 91 and the bolt 84.

FIG. 13 is an exemplary side view of a hydrodynamic bearing 95 according to one example. The hydrodynamic bearing 95 of this example is arranged between the revolver 40 and the bolt 84. The hydrodynamic bearing 95 comprises an oil film 99, here radially outside of the bolt 84 and radially inside of the revolver 40. As illustrated in FIG. 13, the revolver 40 may become slightly eccentric with respect to the bolt 84 during rotation of the revolver 40. The eccentricity creates different pressures in the oil film 99 causing a reaction force to reduce the eccentricity.

The hydrodynamic bearing 95 is a further example of a fluid bearing according to the disclosure. In case the hydrostatic bearing 88 in FIG. 11 is replaced with the hydrodynamic bearing 95, the inner channel 92 may be omitted. Moreover, the hydrodynamic bearing 95 may require fewer parts than the hydrostatic bearing 88, such as no hydrostatic piston 91 and no O-ring 97, which may lead to a more cost-efficient solution.

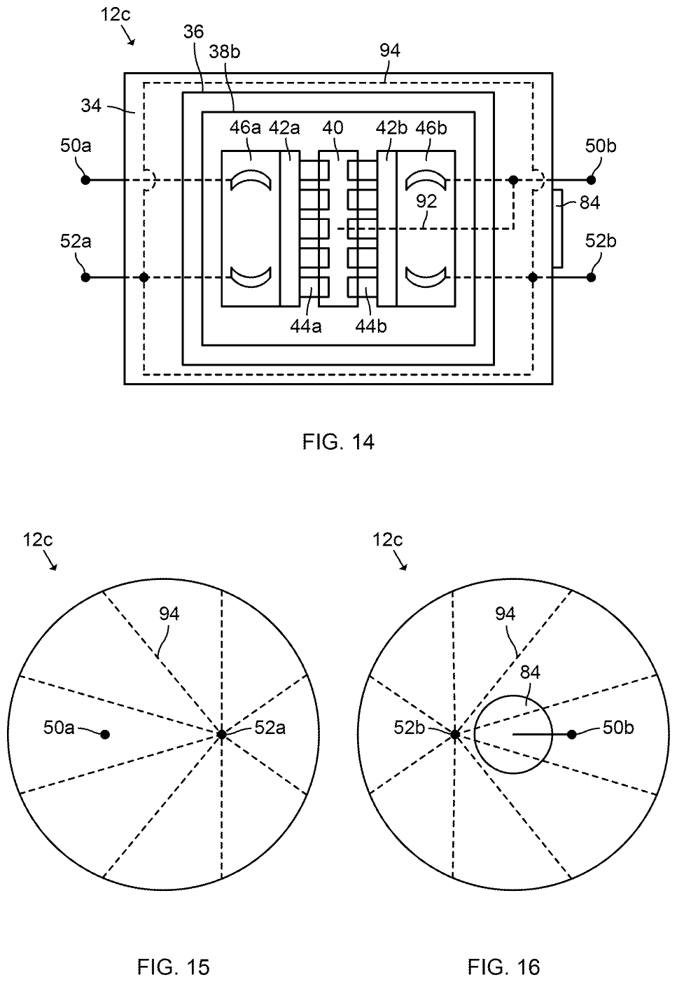

FIG. 14 is an exemplary top view of the electro-hydraulic apparatus 12c. As shown, the inner channel 92 is in fluid communication with the second high-pressure hydraulic port 50b. Moreover, the outer channels 94 are in fluid communication with each of the low-pressure hydraulic ports 52a, 52b. Similar to the electro-hydraulic apparatus 12a in FIG. 4, the electro-hydraulic apparatus 12c in FIG. 14 comprises two hydraulic ports 50a, 52a on a same side of the revolver 40 as the first piston plate 42a and two hydraulic ports 50b, 52b on a same side of the revolver 40 as the second piston plate 42b. The first low-pressure hydraulic port 52a is in fluid communication with the second low-pressure hydraulic port 52b via the outer channels 94 outside the stator 64. The hydraulic ports 50a, 52a are here provided at a first side of the housing 34 and the hydraulic ports 50b, 52b are here provided at a second side of the housing 34, opposite to the first side. In this example, the outer channels 94 are provided entirely inside the housing 34.

FIG. 15 shows one of many examples of how the outer channels 94 can be branched radially outwards from the first low-pressure hydraulic port 52a.

FIG. 16 is a further exemplary view of a second end of the electro-hydraulic apparatus 12c. FIG. 16 shows one of many examples of how the outer channels 94 can be branched radially inwards to the second low-pressure hydraulic port 52a.

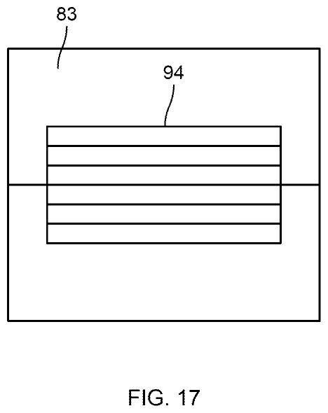

FIG. 17 is an exemplary top view of the central section 83 and an outer channel 94 according to one example. As shown in FIG. 17, the outer channel 94 branches into a plurality of sub-channels, and the plurality of sub-channels merge back into the outer channel 94 over the stator 64. As an alternative to providing the outer channel 94 in the central section 83, the outer channel 94 may be provided in the stator 64, such as in laminations thereof.

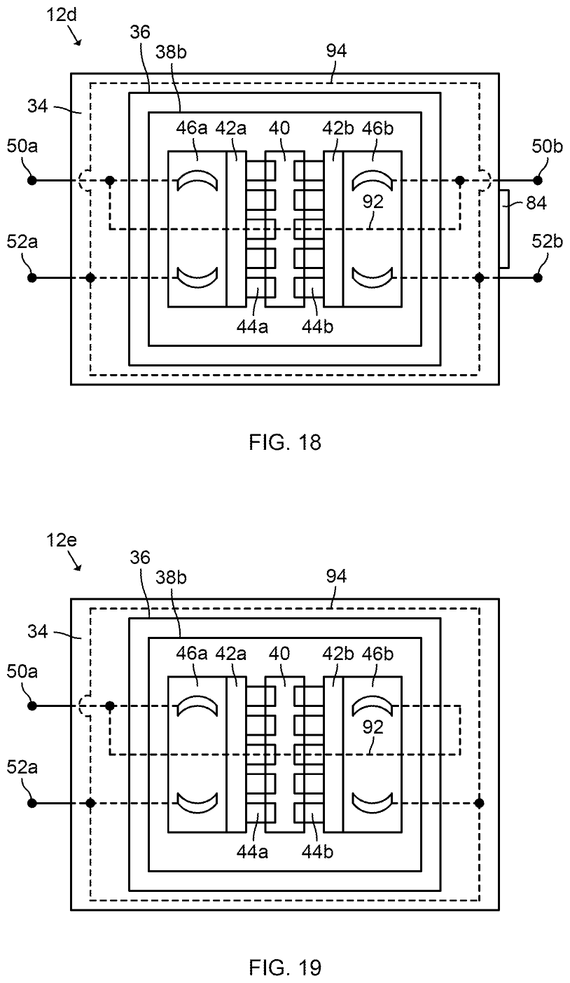

FIG. 18 is an exemplary top view of an electro-hydraulic apparatus 12d according to a further example. The electro-hydraulic apparatus 12d differs from the electro-hydraulic apparatus 12c in that the first high-pressure hydraulic port 50a is in fluid communication with the second high-pressure hydraulic port 50b through the inner region 76 and by means of the inner channel 92. The inner channel 92 of this example thus passes through the revolver 40 and radially inside of the revolver 40.

FIG. 19 is an exemplary top view of an electro-hydraulic apparatus 12e according to a further example. The electro-hydraulic apparatus 12e differs from the electro-hydraulic apparatus 12d in that the electro-hydraulic apparatus 12e comprises only two hydraulic ports 50a, 52a. In FIG. 19, the two hydraulic ports 50a, 52a are both arranged at the first side of the housing 34, i.e., at the same side of the revolver 40 as the first piston plate 42a. The electro-hydraulic apparatus 12e however still comprises the outer channels 94 and the inner channel 92.

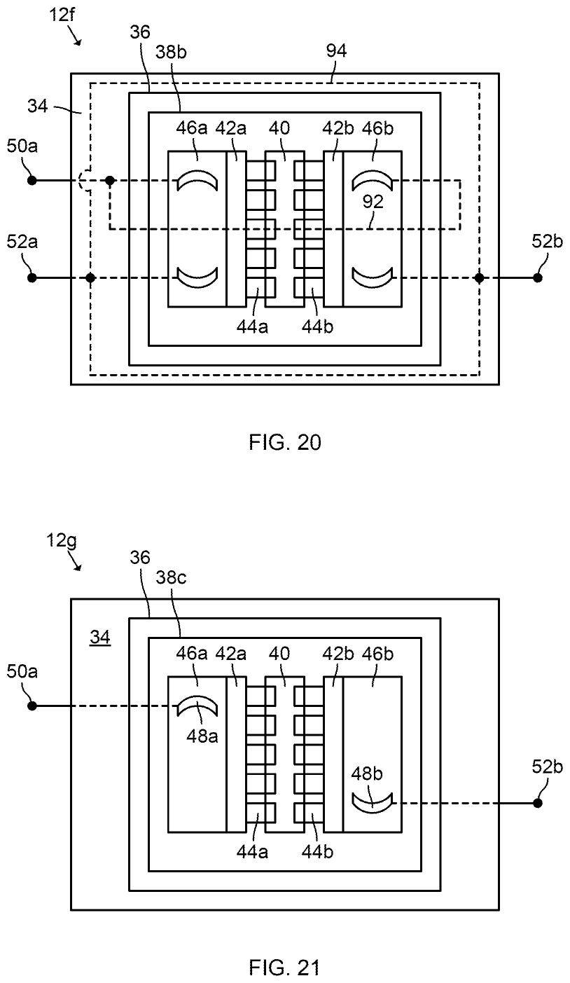

FIG. 20 is an exemplary top view of an electro-hydraulic apparatus 12f according to a further example. The electro-hydraulic apparatus 12f differs from the electro-hydraulic apparatus 12e in that the electro-hydraulic apparatus 12f additionally comprises the hydraulic port 52b on the second side of the housing 34.

FIG. 21 is an exemplary top view of an electro-hydraulic apparatus 12g according to a further example. The electro-hydraulic apparatus 12g differs from the electro-hydraulic apparatus 12f by comprising a hydraulic machine 38c. The hydraulic machine 38c in turn differs from the hydraulic machine 38b by comprising a first valve plate 46a having only a first passageway 48a (i.e., not a second passageway) and a second valve plate 46b having only a second passageway 48b (i.e., not a first passageway). In the example of FIG. 21, the inner region 76 may not be used to transmit hydraulic fluid through the revolver 40. In this way, more space becomes available for other functions, such as for the hydrostatic bearing 88.

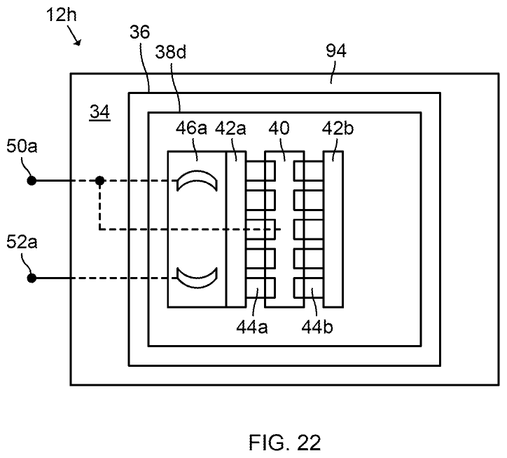

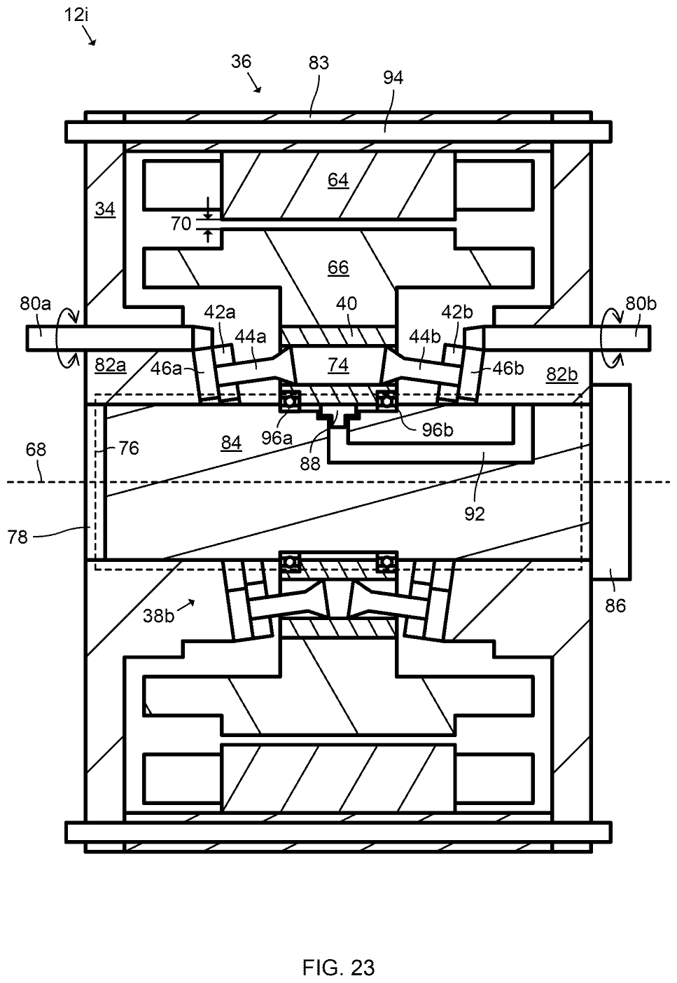

FIG. 22 is an exemplary top view of an electro-hydraulic apparatus 12h according to a further example. Mainly differences with respect to the electro-hydraulic apparatus 12e in FIG. 19 will be described. The electro-hydraulic apparatus 12h of this example comprises a hydraulic machine 38d. The hydraulic machine 38d differs from the hydraulic machine 38b by not comprising the second valve plate 46b. Moreover, the second pistons 44b of this example are solid, i.e., not hollow. The outer channel 94 of the electro-hydraulic apparatus 12e may or may not be provided in the electro-hydraulic apparatus 12h.

FIG. 23 is an exemplary cross-sectional side view of an electro-hydraulic apparatus 12i according to a further example. Mainly differences with respect to the electro-hydraulic apparatus 12c in FIG. 11 will be described. The electro-hydraulic apparatus 12i comprises a first rolling element bearing 96a and a second rolling element bearing 96b. The rolling element bearings 96a, 96b are arranged inside the inner region 76. More specifically, the first and second rolling element bearings 96a, 96b are arranged between the bolt 84 and the revolver 40 and supports rotation of the revolver 40 relative to the bolt 84. In comparison with the rolling element bearings 72a, 72b of the electro-hydraulic apparatus 12c in FIG. 11, the rolling element bearings 96a, 96b are smaller in size and are positioned inside the inner region 76. The relatively small rolling element bearings 96a, 96b in combination with the hydrostatic bearing 88 enables removal of the rolling element bearings 72a, 72b outside the inner region 76. The electro-hydraulic apparatus 12i can thereby be made more compact.

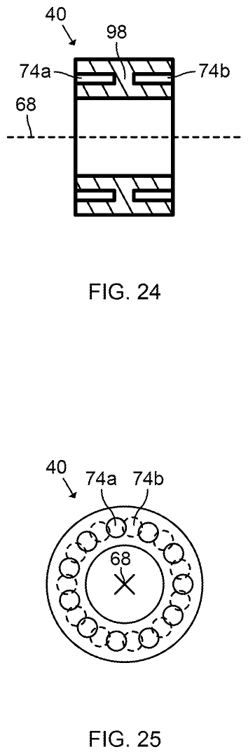

FIG. 24 is an exemplary cross-sectional side view of a revolver 40 according to one example, and FIG. 25 is an exemplary end view of the revolver 40 in FIG. 24. With collective reference to FIGS. 24 and 25, the revolver 40 of this example comprises first cylinders 74a, second cylinders 74b and a wall 98 separating the first and second cylinders 74a, 74b. The first cylinders 74a are arranged to receive the first pistons 44a. The second cylinders 74b are arranged to receive the second pistons 44b. As particularly shown in FIG. 25, there is a rotational offset between the first and second cylinders 74a, 74b with respect to the rotation axis 68. In this way, the discharge strokes and the suction strokes of the first and second pistons 44a, 44b become out of phase. This provides an improved balancing of axial forces. Moreover, due to the discharge strokes and the suction strokes being out of phase, there is a double amount of piston strokes for one revolution of the revolver 40 which will reduce the pressure pulse amplitude by half while doubling the pressure pulse frequency. This in turn enables a reduced noise, e.g., due to a lower energy of each pressure pulse which can more easily be suppressed.

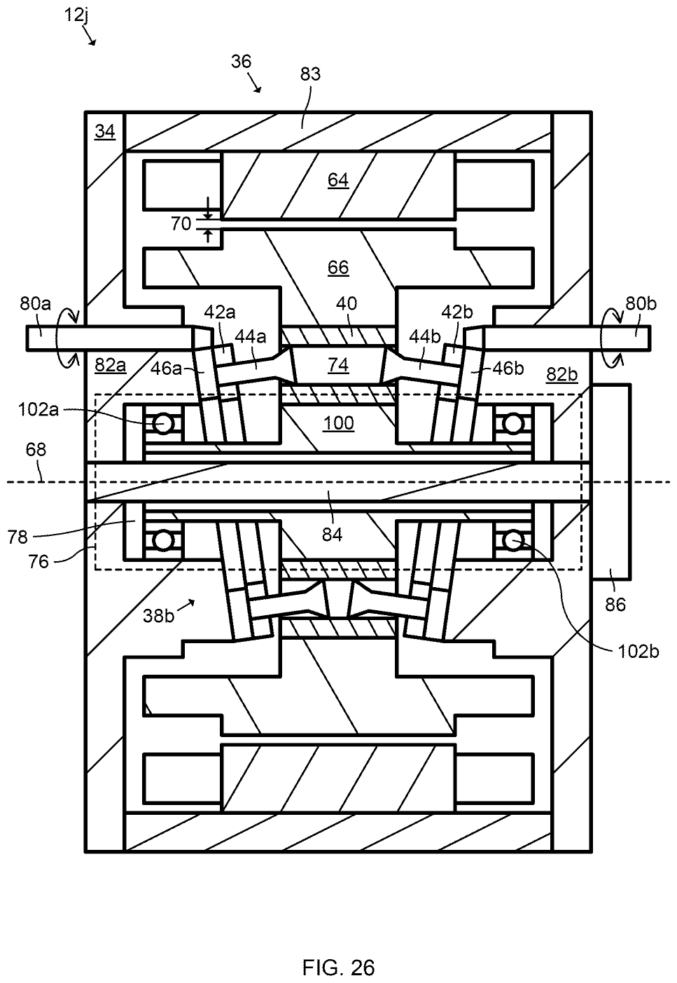

FIG. 26 is an exemplary cross-sectional side view of an electro-hydraulic apparatus 12j according to a further example. Mainly differences with respect to the electro-hydraulic apparatus 12b in FIG. 10 will be described. The electro-hydraulic apparatus 12j further comprises a shaft 100. In the specific and non-limiting example in FIG. 26, the bolt 84 is thinner than in FIG. 10 and passes through the shaft 100 with a clearance. The bolt 84 and the shaft 100 form a further example of a center element according to the present disclosure. As shown, the shaft 100 of this example is positioned inside the inner region 76. The shaft 100 is fixed to the revolver 40 and is hence also rotatable around the rotation axis 68. In an alternative variant of the center element, the center element comprises the shaft 100 but not the bolt 84.

The electro-hydraulic apparatus 12j further comprises a first rolling element bearing 102a and a second rolling element bearing 102b. The revolver 40 is positioned between the rolling element bearings 102a, 102b. The first rolling element bearing 102a is provided between the first section 82a and the shaft 100. The second rolling element bearing 102b is provided between the second section 82b and the shaft 100. The first and second rolling element bearings 102a, 102b thus support rotation of the shaft 100 and of the revolver 40 relative to the housing 34. The first and second rolling element bearings 102a, 102b are here illustrated as radial bearings but may alternatively be of another type, such as thrust bearings.

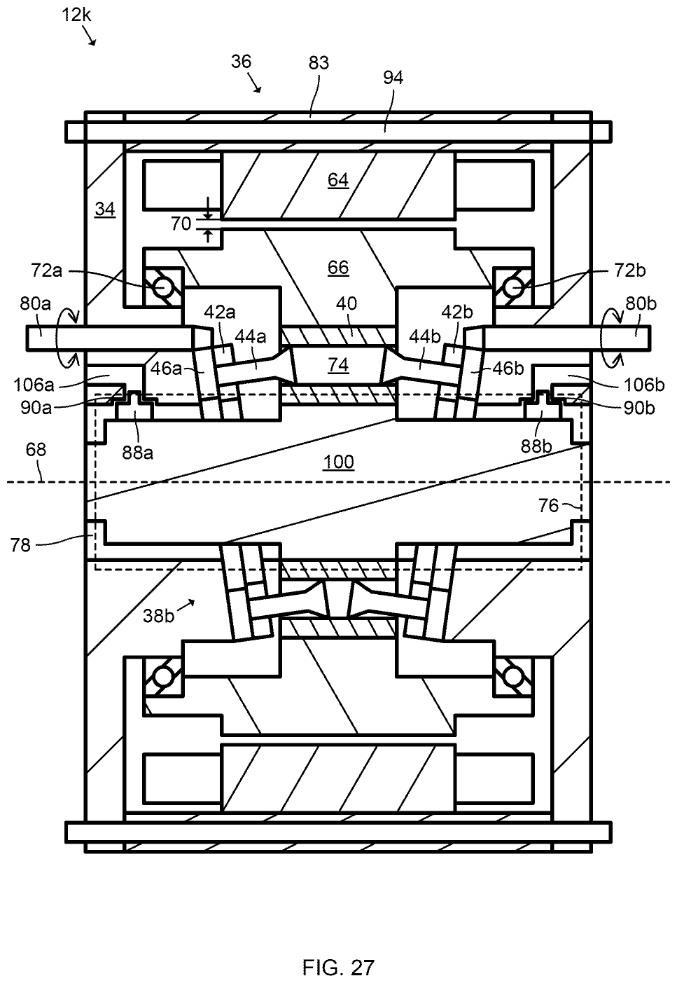

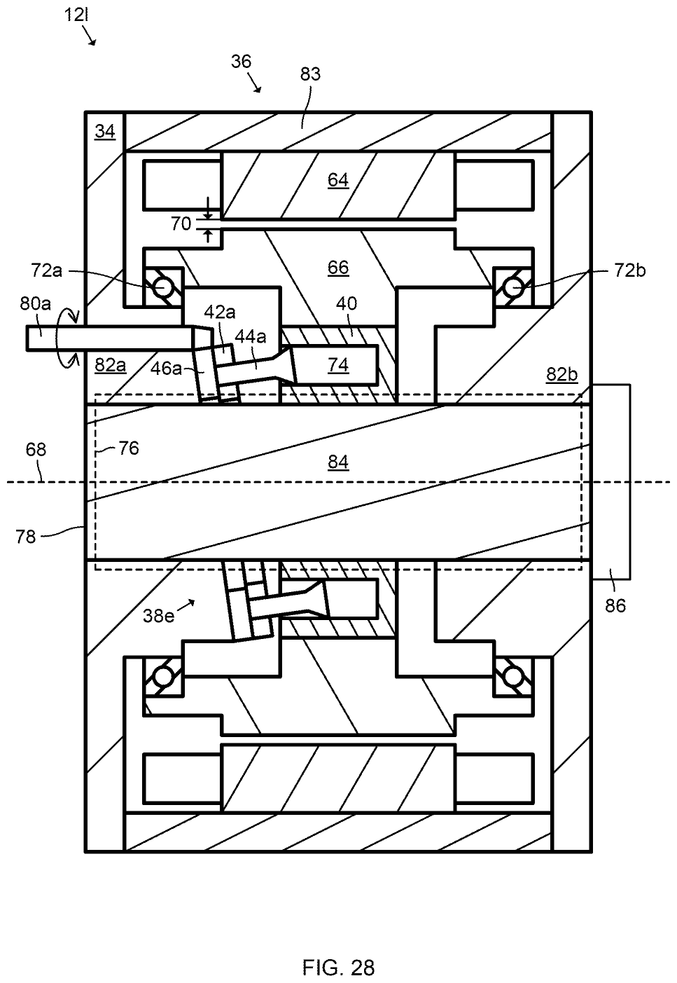

FIG. 27 is an exemplary cross-sectional side view of an electro-hydraulic apparatus 12k according to a further example. The electro-hydraulic apparatus 12k of this example does not comprise the bolt 84. Instead, as shown in FIG. 27, the shaft 100 of this example is solid. The shaft 100 in FIG. 27, whether solid or not, constitutes a further example of a center element according to the disclosure.

The electro-hydraulic apparatus 12k further comprises a first hydrostatic bearing 88a and a second hydrostatic bearing 88b. The first hydrostatic bearing 88a is received in a first seat 90a in the first section 82a of the housing 34. The second hydrostatic bearing 88b is received in a second seat 90b in the second section 82b of the housing 34. Each of the hydrostatic bearings 88a, 88b may be of the type illustrated in FIG. 12, although positioned at different locations in the electro-hydraulic apparatus 12k.

The electro-hydraulic apparatus 12k further comprises a first channel 106a in the first section 82a providing hydraulic fluid to the first hydrostatic bearing 88a and a second channel 106b in the second section 82b providing hydraulic fluid to the second hydrostatic bearing 88b. The channels 106a, 106b are in fluid communication with the high-pressure side of the hydraulic machine 38b. Also in this example, the hydrostatic bearings 88a, 88b support rotation of the revolver 40, here via an intermediate element constituted by the shaft 100.

FIG. 28 is an exemplary cross-sectional side view of an electro-hydraulic apparatus 12l according to a further example. The electro-hydraulic apparatus 12l differs from the electro-hydraulic apparatus 12b by comprising a hydraulic machine 38e instead of the hydraulic machine 38b. The hydraulic machine 38e differs from the hydraulic machine 38b by being one-sided rather than two-sided. That is, the hydraulic machine 38e comprises only one set of a valve plate 46a, a piston plate 42a and associated pistons 44a. Moreover, rather than being through holes, the cylinders 74 of the revolver 40 of the hydraulic machine 38e are blind bores.

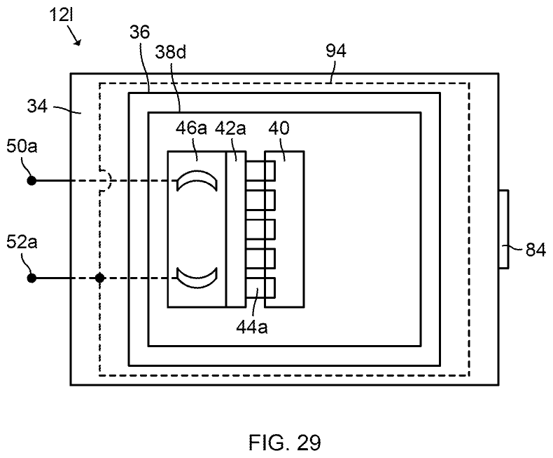

FIG. 29 is an exemplary top view of the electro-hydraulic apparatus 12l in FIG. 28. As shown, the electro-hydraulic apparatus 12l of this example comprises only two hydraulic ports 50a, 52a on one side of the housing 34.

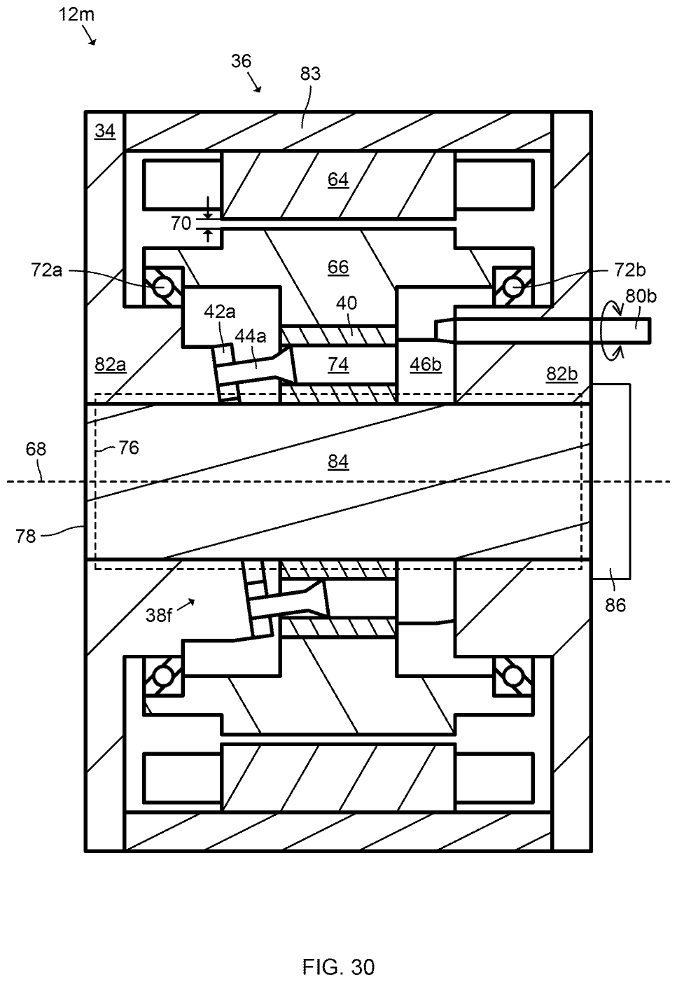

FIG. 30 is an exemplary cross-sectional side view of an electro-hydraulic apparatus 12m according to a further example. Mainly differences with respect to the electro-hydraulic apparatus 12l in FIG. 28 will be described. The electro-hydraulic apparatus 12m comprises a hydraulic machine 38f. In the hydraulic machine 38f, the cylinders 74 are through holes. Moreover, instead of the only the first valve plate 46a in the hydraulic machine 38c, the hydraulic machine 38f comprises only the second valve plate 46b. Correspondingly, instead of the first rotation control element 80a in the hydraulic machine 38c, the hydraulic machine 38f comprises the second rotation control element 80b. In FIG. 30, the pistons 44a may optionally be solid, i.e., not hollow. In any case, hydraulic fluid is not communicated between the cylinders 74 and the first section 82a through the pistons 44a. Instead, the second valve plate 46b communicates hydraulic fluid between the cylinders 74 and the second section 82b. The second valve plate 46b is here oriented transverse to the rotation axis 68. A sliding interface is provided between the revolver 40 and the second valve plate 46b. One, several or all of the hydraulic machines 38a-38f may also be referred to with reference numeral “38”.

Each electro-hydraulic apparatus 12a-12m may be used as the electro-hydraulic apparatus 12 in any of the vehicles 10a-10c or in any other vehicle. One, several or all of the electro-hydraulic apparatuses 12a-12m may also be referred to with reference numeral “12”.

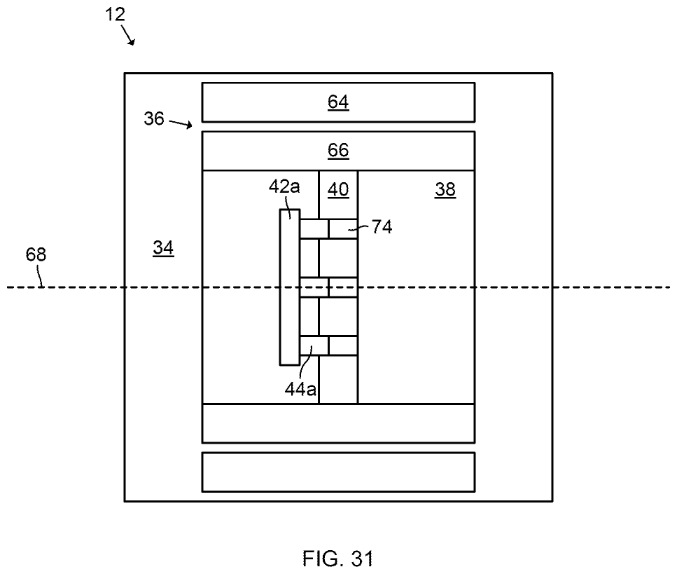

FIG. 31 is another view of FIG. 4, according to an example. FIG. 31 shows an electro-hydraulic apparatus 12 comprising a base structure 34; an electric machine 36 comprising a stator 64 fixed to the base structure 34 and a rotor 66 rotatable about a rotation axis 68, the rotor 66 being positioned radially inside of the stator 64 with respect to the rotation axis 68; and a hydraulic machine 38 comprising a revolver 40 fixed to the rotor 66 and including a plurality of cylinders 74, at least one piston plate 42a, and a plurality of pistons 44a fixed to the at least one piston plate 42a, each piston 44a being arranged to reciprocate inside one of the cylinders 74 during rotation of the revolver 40 to perform suction strokes and discharge strokes.

Example 1: An electro-hydraulic apparatus 12 comprising a base structure 34; an electric machine 36 comprising a stator 64 fixed to the base structure 34 and a rotor 66 rotatable about a rotation axis 68, the rotor 66 being positioned radially inside of the stator 64 with respect to the rotation axis 68; and a hydraulic machine 38 comprising a revolver 40 fixed to the rotor 66 and including a plurality of cylinders 74; 74a, 74b, at least one piston plate 42a, 42b, and a plurality of pistons 44a, 44b fixed to the at least one piston plate 42a, 42b, each piston 44a, 44b being arranged to reciprocate inside one of the cylinders 74; 74a, 74b during rotation of the revolver 40 to perform suction strokes and discharge strokes.

Example 2: The electro-hydraulic apparatus 12 of example 1, wherein each piston plate 42a, 42b has a main extension plane 62, and wherein each piston 44a, 44b is fixed in an orientation perpendicular to the associated main extension plane 62.

Example 3: The electro-hydraulic apparatus 12 of any of the preceding examples, wherein one or more of the pistons 44a, 44b fixed to one or more of the at least one piston plate 42a, 42b are hollow such that hydraulic fluid can pass through the pistons 44a, 44b.

Example 4: The electro-hydraulic apparatus 12 of any of the preceding examples, wherein the hydraulic machine 38 is arranged to provide pressurized hydraulic fluid to an inner region 76 radially inside of the cylinders 74; 74a, 74b, and axially within the base structure 34, with respect to the rotation axis 68.

Example 5: The electro-hydraulic apparatus 12 of any of the preceding examples, further comprising a center element 84, 100 passing through the revolver 40.

Example 6: The electro-hydraulic apparatus 12 of example 5, wherein the center element 84 is fixed to the base structure 34.

Example 7: The electro-hydraulic apparatus 12 of example 6, wherein the center element 84 engages a first section 82a of the base structure 34 and a second section 82b of the base structure 34 on an opposite side of the revolver 40 with respect to the first section 82a.

Example 8: The electro-hydraulic apparatus 12 of example 4 and any of examples 5 to 7, wherein the inner region 76 is positioned entirely inside the center element 84.

Example 9: The electro-hydraulic apparatus 12 of any of the preceding examples, further comprising at least one fluid bearing 88, 88a, 88b, 95 supporting the revolver 40.

Example 10: The electro-hydraulic apparatus 12 of example 9, wherein each fluid bearing 88, 88a, 88b is a hydrostatic bearing provided with pressurized hydraulic fluid from the hydraulic machine 38.

Example 11: The electro-hydraulic apparatus 12 of examples 4 and 10, or of examples 4, 10 and any of examples 5 to 9, wherein the at least one fluid bearing 88 is provided with pressurized hydraulic fluid via the inner region 76.

Example 12: The electro-hydraulic apparatus 12 of example 5, wherein the center element 100 comprises a shaft 100 fixed to the revolver 40.

Example 13: The electro-hydraulic apparatus 12 of example 12, wherein the electro-hydraulic apparatus 12 comprises a rolling element bearing 102a, 102b on each side of the revolver 40 supporting rotation of the shaft 100 relative to the base structure 34.

Example 14: The electro-hydraulic apparatus 12 of any of the preceding examples, wherein the at least one piston plate 42a, 42b comprises a first piston plate 42a and a second piston plate 42b arranged on an opposite side of the revolver 40 with respect to the first piston plate 42a.

Example 15: The electro-hydraulic apparatus 12 of example 14, wherein the electro-hydraulic apparatus 12 comprises two hydraulic ports 50a, 52a on a same side of the revolver 40 as the first piston plate 42a and two hydraulic ports 50b, 52b on a same side of the revolver 40 as the second piston plate 42b, and wherein at least one hydraulic port 50a, 52a of the hydraulic ports 50a, 52a on the same side of the revolver 40 as the first piston plate 42a is in fluid communication with at least one hydraulic port 50b, 52b of the hydraulic ports 50b, 52b on the same side of the revolver 40 as the second piston plate 42b.

Example 16: The electro-hydraulic apparatus 12 of examples 4 and 15, or of examples 4, 15 and any of examples 5 to 13, wherein at least one hydraulic port 50a of the hydraulic ports 50a, 52a on the same side of the revolver 40 as the first piston plate 42a and at least one hydraulic port 50b of the hydraulic ports 50b, 52b on the same side of the revolver 40 as the second piston plate 42b are in fluid communication through the inner region 76.

Example 17: The electro-hydraulic apparatus 12 of example 15 or 16, wherein the electro-hydraulic apparatus 12 comprises at least one outer channel 94 passing radially outside of the stator 64 with respect to the rotation axis 68 and along the stator 64 for communicating fluid between at least one hydraulic port 52a of the hydraulic ports 50a, 52a on the same side of the revolver 40 as the first piston plate 42a and at least one hydraulic port 52b of the hydraulic ports 50b, 52b on the same side of the revolver 40 as the second piston plate 42b.

Example 18: The electro-hydraulic apparatus 12 of any of examples 14 to 17, wherein the electro-hydraulic apparatus 12 is arranged such that the discharge strokes of the pistons 44a fixed to the first piston plate 42a are out of phase with the discharge strokes of the pistons 44b fixed to the second piston plate 42b.

Example 19: The electro-hydraulic apparatus 12 of example 18, wherein the cylinders 74; 74a, 74b comprise first cylinders 74a receiving the pistons 44a fixed to the first piston plate 42a and second cylinders 74b receiving the pistons 44b fixed to the second piston plate 42b, and wherein the revolver 40 comprises a wall 98 separating the first cylinders 74a from the second cylinders 74b.

Example 20: The electro-hydraulic apparatus 12 according to example 19, wherein the first cylinders 74a and the second cylinders 74b are rotationally offset with respect to the rotation axis 68.

Example 21: The electro-hydraulic apparatus 12 of example 14, wherein the electro-hydraulic apparatus 12 comprises only two hydraulic ports 50a, 50b, 52a, 52b.

Example 22: The electro-hydraulic apparatus 12 of example 21, wherein the two hydraulic ports 50a, 50b, 52a, 52b comprise only hydraulic port 50a on a same side of the revolver 40 as the first piston plate 42a and one hydraulic port 52b on a same side of the revolver 40 as the second piston plate 42b.

Example 23: The electro-hydraulic apparatus 12 of example 21, wherein the two hydraulic ports 50a, 52a are positioned on a same side of the revolver 40 as one piston plate 42a.

Example 24: A vehicle 10a-10c comprising an electro-hydraulic apparatus 12 according to any of the preceding examples.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. An electro-hydraulic apparatus comprising:
a base structure;
an electric machine comprising a stator fixed to the base structure and a rotor rotatable about a rotation axis, the rotor being positioned radially inside of the stator with respect to the rotation axis; and
a hydraulic machine comprising a revolver fixed to the rotor and including a plurality of cylinders, at least one piston plate, and a plurality of pistons fixed to the at least one piston plate, each piston being arranged to reciprocate inside one of the cylinders during rotation of the revolver to perform suction strokes and discharge strokes.

2. The electro-hydraulic apparatus of claim 1, wherein each piston plate has a main extension plane, and wherein each piston is fixed in an orientation perpendicular to the associated main extension plane.

3. The electro-hydraulic apparatus of claim 1, wherein one or more of the pistons fixed to one or more of the at least one piston plate are hollow such that hydraulic fluid can pass through the pistons.

4. The electro-hydraulic apparatus of claim 1, wherein the hydraulic machine is arranged to provide pressurized hydraulic fluid to an inner region radially inside of the cylinders, and axially within the base structure, with respect to the rotation axis.

5. The electro-hydraulic apparatus of claim 1, further comprising a center element passing through the revolver.

6. The electro-hydraulic apparatus of claim 5, wherein the center element is fixed to the base structure.

7. The electro-hydraulic apparatus of claim 6, wherein the center element engages a first section of the base structure and a second section of the base structure on an opposite side of the revolver with respect to the first section.

8. The electro-hydraulic apparatus of claim 4, further comprising a center element passing through the revolver, wherein the inner region is positioned entirely inside the center element.

9. The electro-hydraulic apparatus of claim 1, further comprising at least one fluid bearing supporting the revolver.

10. The electro-hydraulic apparatus of claim 9, wherein each fluid bearing is a hydrostatic bearing provided with pressurized hydraulic fluid from the hydraulic machine.

11. The electro-hydraulic apparatus of claim 4, wherein the at least one fluid bearing is provided with pressurized hydraulic fluid via the inner region.

12. The electro-hydraulic apparatus of claim 5, wherein the center element comprises a shaft fixed to the revolver.

13. The electro-hydraulic apparatus of claim 12, further comprising a rolling element bearing on each side of the revolver supporting rotation of the shaft relative to the base structure.

14. The electro-hydraulic apparatus of claim 1, wherein the at least one piston plate comprises a first piston plate and a second piston plate arranged on an opposite side of the revolver with respect to the first piston plate.

15. The electro-hydraulic apparatus of claim 14, wherein the electro-hydraulic apparatus comprises two hydraulic ports on a same side of the revolver as the first piston plate and two hydraulic ports on a same side of the revolver as the second piston plate, and wherein at least one hydraulic port of the hydraulic ports on the same side of the revolver as the first piston plate is in fluid communication with at least one hydraulic port of the hydraulic ports on the same side of the revolver as the second piston plate.

16. The electro-hydraulic apparatus of claim 4, wherein at least one hydraulic port of the hydraulic ports on the same side of the revolver as the first piston plate and at least one hydraulic port of the hydraulic ports on the same side of the revolver as the second piston plate are in fluid communication through the inner region.

17. The electro-hydraulic apparatus of claim 15, wherein the electro-hydraulic apparatus comprises at least one outer channel passing radially outside of the stator with respect to the rotation axis and along the stator for communicating fluid between at least one hydraulic port of the hydraulic ports on the same side of the revolver as the first piston plate and at least one hydraulic port of the hydraulic ports on the same side of the revolver as the second piston plate.

18. The electro-hydraulic apparatus of claim 14, wherein the electro-hydraulic apparatus is arranged such that the discharge strokes of the pistons fixed to the first piston plate are out of phase with the discharge strokes of the pistons fixed to the second piston plate.

19. The electro-hydraulic apparatus of claim 18, wherein the cylinders comprise first cylinders receiving the pistons fixed to the first piston plate and second cylinders receiving the pistons fixed to the second piston plate, and wherein the revolver comprises a wall separating the first cylinders from the second cylinders.

20. The electro-hydraulic apparatus according to claim 19, wherein the first cylinders and the second cylinders are rotationally offset with respect to the rotation axis.
